(19) United States
(12) Patent Application Publication
(10) Pub. No.: US 2007/0097282 A1
(43) Pub. Date: May 3, 2007

(54) Thin film multilayer substrate, manufacturing method thereof, and liquid crystal display having thin film multilayer substrate

(75) Inventors: Takafumi Hashiguchi, Tokyo (JP); Shinji Kawabuchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/528,387

(22) Filed: Sep. 28, 2006

(30) Foreign Application Priority Data
Oct. 31, 2005 (JP) 2005-315777

(51) Int. Cl. G02F 1/136

(52) U.S. Cl. 349/43

(57) ABSTRACT

A thin film multilayer substrate includes a planarizing film having bumpy pattern on its surface, a plurality of first conductive parts below the planarizing film, and a second conductive parts above the planarizing film. The bumpy pattern on the surface of the planarizing film is formed in regions where salient parts of the first conductive parts are formed excluding regions the second conductive parts formed therein.

### BACKGROUND OF THE INVENTION

1. Field of the Invention

The present invention relates to a thin film multilayer substrate, a manufacturing method thereof, and a liquid crystal display having a thin film multilayer substrate.

2. Description of the Related Art

A liquid crystal display generally comprises a liquid crystal layer having a liquid crystal held between two substrates with electrodes. A polarizing plate is mounted to the bottom and top of the substrates. For a transparent liquid crystal display, a backlight is provided to the back. An incident light from the backlight passing through a polarizing plate changes to an elliptical polarization due to birefringence of liquid crystal, and incidents to a polarizing plate on the other side. If a voltage is applied between the electrodes on top and bottom at this time, an alignment of liquid crystal directors and the birefringence of liquid crystal change, thereby changing an elliptical polarization condition of light incidenting to the polarizing plate on the other side. Consequently an electrooptic effect for changing spectrum and intensity of light transmitting the liquid crystal display can be achieved.

A liquid crystal display can be categorized into transparent liquid crystal display, reflecting liquid crystal display, and transflective (semi-transmissive) liquid crystal display. A transparent liquid crystal display has a backlight to its back or side to display images.

A reflecting liquid crystal display displays images by a reflector plate mounted on a substrate that reflects surrounding light on its surface. FIG. 11 shows a cross-sectional diagram showing main part of a thin film transistor array substrate (hereinafter referred to as TFT array substrate) used in a conventional reflecting liquid crystal display, disclosed in Japanese Unexamined Patent Application Publication No. 2001-330827 (hereinafter referred to as a first conventional technique). A TFT array substrate 100 includes an insulating substrate 101, a gate line 102, a gate insulating layer 104, a semiconductor film 105, a drain electrode 107, a source electrode 108, an interlayer insulating film 109, a planarizing film 110, and a pixel electrode 111 that also functions as a reflector plate.

In the TFT array substrate 100, a plurality of openings 117 are formed at the same time as a contact hole 115 after forming the interlayer insulating film 109 as shown FIG. 11. After that, form the planarizing film 110 thereabove. This achieves the planarizing film having bumpy pattern 118 on its surface. Then, form a metal for forming the pixel electrode 111 so as to form the pixel electrode 111 at a desired location as shown in FIG. 11. Consequently the pixel electrode 111 having bumpy pattern can be formed that corresponds to the openings 117 of the interlayer insulating film 109.

A technique to form the openings 117 formed in the interlayer insulating film 109 and the gate insulating layer 104 so that the openings 117 cross over lines, thin film transistor, and storage capacitor part, leading an insulating film or a glass substrate formed below the openings 117 is not etched at the same time. In a case the insulating film or the glass substrate formed below the openings 117 is etched at the same time, it is possible that a cavity is created below line or a line could be damaged, increasing wiring resistance.

For a transflective liquid crystal display (disclosed in Japanese Unexamined Patent Application Publication No. 7-333598, Japanese Unexamined Patent Application Publication No. 2000-19563, and Japanese Unexamined Patent Application Publication No. 2000-305110, for example), a portion of light penetrates and a portion of light is reflected. The transflective liquid crystal display covers a shortcoming of a transparent liquid crystal display that if surrounding light is overly bright, it is difficult to observe its display because the display light is dark in comparison with the surrounding light, and also a shortcoming of a reflecting liquid crystal display that visibility worsens enormously in a case surrounding light is dark.

FIG. 12 is a plan view showing a pixel of a TFT array substrate 200 of a transflective liquid crystal display according to a conventional technique (hereinafter referred to as a second conventional technique). FIG. 13 is a cross-sectional diagram taken along the line IV-IV of FIG. 12. The TFT array substrate 200 includes an insulating substrate 201, a gate line 202, an storage capacitor line 203, a gate insulating layer 204, a semiconductor active film 205, which is a first semiconductor film, an ohmic contact film 206, which is a second semiconductor film, a drain electrode 207, a source electrode 208, an interlayer insulating film 209, a planarizing film 210, a pixel electrode 211, and a reflecting electrode 212 that also functions as a reflector plate.

The TFT array substrate 200 can be manufactured as described hereinafter, for example. Firstly form a thin metallic film by a method such as sputtering on the transparent insulating substrate 202, so as to form the gate line 202, a gate electrode (not shown), and the storage capacitor line 203. After that, form a gate line, a gate electrode, and a gate terminal by a first photolithography process.

Then, sequentially form the gate insulating film 204 such as SiN, the semiconductor active film 205 such as a-Si, and the ohmic contact film 206 such as n type a-Si by plasma CVD method. After that, pattern the semiconductor active film 205 and the ohmic contact film 206 by a second photolithography process at least to a portion where TFT is formed. The gate insulating film 204 remains all over the surface.

Then, form a thin metallic film by a method such as sputtering to form the drain electrode 207 and the source electrode 208. After that, pattern the thin metallic film by a third photolithography process to form the source electrode 208 and the drain electrode 207. Then etch the ohmic contact film 206. This process removes central part of the ohmic contact film 206 of the TFT portion, consequently exposing the semiconductor active film 205.

Further, form a film to form the interlayer insulating film 209 by plasma CVD method. Then coat photosensitive resin composition to form a photosensitive organic film as the planarizing film 210. After that, form a desired pattern layout and bumpy pattern for the planarizing film 210 by photolithography process. Firstly expose the planarizing film 210 having no pattern formed thereon using a light-shielding mask (photomask) 220 having a light-shielding part 222 shown in FIG. 14 evenly and with low light intensity. Then expose the planarizing film 210 using a light-shielding mask (not shown) having openings that correspond to a transparent region 216 as shown in FIG. 1 evenly and with high light intensity.

As shown in FIG. 14, the light-shielding mask 220 includes light transmission parts 221 having same circular shape. Using the light-shielding mask 220, expose the TFT array substrate 200 with low light intensity of a level whereby the planarizing film 210 is not opened to a layer below. This creates bumpy pattern shown in FIG. 13 on the surface of the planarizing film 210. Then form conductive films for forming the pixel electrode 211 with transparency and the reflecting electrode 212 with reflectivity so as to form desired patterns. This creates the pixel electrodes 211 and the reflecting electrode 212 having bumpy pattern on their surface. A region R1 of the reflecting electrode 212 having bumpy pattern functions as a reflector plate that reflects surrounding light on its surface to display images. A region R2 pervious to light has the pixel electrode 211 formed therein, being removed with the gate insulating film 404, the interlayer insulating film 209, and the planarizing film 210 (for example Japanese Unexamined Patent Application Publication No. 2004-294805).

A TFT array substrate formed as above is bonded with opposing substrate having opposing electrode. And the liquid crystal is injected in between the substrates. It is then mounted to a light emitting side of a planar light source device. This is how a transflective liquid crystal display is manufactured.

Another conventional technique for evenly forming bumpy pattern on a reflector plate with high repeatability is disclosed in Japanese Unexamined Patent Application Publication No. 2000-284272. This is said to achieve a favorable reflection characteristic.

The first conventional technique cannot be applied to a transflective liquid crystal display because bumpy pattern is created to the pixel electrode 111 by forming the gate insulating film 104 and the interlayer insulating film 109. Furthermore the openings are created directly in the gate insulating film 104 and the interlayer insulating film 109 to form a depression shape of the pixel electrode 111. Therefore other layers underneath are susceptible to damage. It can not obtain relatively high yield factor.

Furthermore in the second conventional technique, display defect such as bright spot could be generated. With an increasing demand of larger sized liquid crystal display and higher resolution, it is extremely significant to prevent such display defects. A main reason for the display defect is that conductive parts above and below the planarizing film 210 being electrically, connected. A conventional technique disclosed in the Japanese Unexamined Patent Application Publication No. 2000-284272 realizes a high reflecting characteristic but is unable to solve the issue of display defect.

The issues mentioned above are explained for a reflecting liquid crystal display and a transflective liquid crystal display. However it is not limited to these but apply to a thin film multilayer substrate that conductive parts mounted to above and below a planarizing film having bumpy pattern is electrically connected.

The present invention takes the issues into consideration and is purported to provide a thin film multilayer substrate, a manufacturing method thereof, and a liquid crystal display having the thin film multilayer substrate that prevents a first conductive part below the planarizing film and a second conductive part above the planarizing film to be electrically short-circuited.

### SUMMARY OF THE INVENTION

According to an aspect of the present invention, there is provided a thin film multilayer substrate that includes a planarizing film having bumpy pattern on its surface on a substrate; a first conductive part having a source line, a gate line, and an storage capacitor line below the planarizing film; a second conductive part above the planarizing film; a region A having a thin film transistor formed therein; and a region B not the region A, and any of the source line, the gate line, and the storage capacitor line are intersected. The bumpy pattern on the surface of the planarizing film is formed to an area excluding an area with different electric potential between the first and the second conductive part among areas where the second conductive part is formed above the regions A and B. The conductive part here includes various lines and electrodes.

According to another aspect of the present invention, there is provided a thin film multilayer substrate that includes a planarizing film with bumpy pattern on its surface on a substrate; a plurality of first conductive parts below the planarizing part; and a second conductive part above the planarizing film. At least a part of the depression poritons of bumpy pattern on the surface of the planarizing film in an area with different electric potential between the first and second conductive part among areas where an salient part of the first conductive part is formed with the second conductive part formed thereabove, is shallower than a depth of the bumpy pattern on the surface of the planarizing film above an area excluding areas where the salient part of the first conductive part is formed thereto. The salient parts of the first conductive part is regions formed to be salient on the surface before forming the planarizing film as compared with other regions due to the first conductive part being formed.

With the thin film multilayer substrate of the second embodiment, a portion where the planarizing film tends to be thin can be thicker as compared to the second conventional technique. This reduces the possibility that the first and the second conductive parts are electrically connected caused by process fluctuation.

According to another aspect of the present invention, there is provided the above thin film multilayer substrate according where the region the salient parts of the first conductive part are formed that includes a region A where a thin film transistor is formed, a region B where any of a source line, a gate line, and an storage capacitor line are intersected and not the region A, and a region C where the source line and the gate lines are formed and not the region B. A depth of depression portions of bumpy pattern on the surface of the planarizing film in an area where the second conductive part is formed above the regions A, B, and C, is shallower than depth of depression poritons of bumpy pattern on the surface of the planarizing film above a region excluding the regions A, B, and C.

According to another aspect of the present invention, there is provided the above thin film multilayer substrate where shapes of bumpy patterns for the regions A, B, and C are different.

According to another aspect of the present invention, there is provided a thin film multilayer substrate that includes a planarizing film with bumpy pattern on its surface on a substrate, a plurality of first conductive parts below the planarizing film, and a second conductive part above the planarizing film. The second conductive part is not formed to at least a part of bottom of bumpy pattern on the surface of the planarizing film above a region where salient parts of the first conductive parts are formed.

With the above thin film multilayer substrate, it is possible to effectively reducing the possibility that the first and the second conductive parts are electrically connected as compared with the second conventional technique by not providing the second conductive part in a part where the planarizing film can be thin. It also prevents display defects such as bright spots, providing a thin film multilayer substrate having a high yield factor.

According to another aspect of the present invention, there is provided the above thin film multilayer substrate that further includes a region A where a thin film transistor is formed, a region B where any of a source line, a gate line, and an storage capacitor line are intersected and not the region A, a region C where the source line and the gate line are formed and not the region B. The second conductive part is not formed at bottom of bumpy pattern on the surface of the planarizing film in the regions A, B, and C.

According to another aspect of the present invention, there is provided a liquid crystal display comprising a thin film transistor substrate of any one of the abovementioned thin film transistors.

According to another aspect of the present invention, there is provided a manufacturing method of a thin film multilayer substrate having a planarizing film with bumpy pattern on its surface on a substrate, a plurality of first conductive parts below the planarizing film, and a second conductive part above the planarizing film that includes forming the first conductive part on the substrate, coating the planarizing film to an upper layer of the first conductive part, adjusting a thickness of the planarizing film depending on a shape of salient parts of the first conductive parts formed below the planarizing film so that the first and the second conductive parts are not electrically connected, and forming the second conductive part above the planarizing film with its thickness being adjusted. The adjustment of the thickness of the planarizing film is performed by changing a shape of bumpy pattern on the surface of the planarizing film according to the shape of the salient parts of the first conductive part.

According to a manufacturing method of a thin film multilayer substrate of the eighth embodiment of the present invention, the part where the planarizing film tends to be thin can be thicker than in the second conventional technique. Accordingly the present invention provides a manufacturing method of a thin film multilayer substrate that reduces the possibility that the first and the second conductive parts are electrically connected caused by fluctuation in process.

The present invention provides a liquid crystal display including a thin film multilayer substrate that prevents the first conductive part located below a planarizing film having bumpy pattern from being electrically connected to the second conductive part above the planarizing film, causing a short out, a manufacturing method thereof, and a liquid crystal display having the thin film multilayer substrate.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

The above and other objects, advantages and features of the present invention will be more apparent from the following description taken in conjunction with the accompanying drawings, in which:

FIG. 1 is a plan view showing a pixel of a TFT substrate according to a first embodiment of the present invention;

FIG. 2 is a cross-sectional diagram taken along the line I-I of FIG. 1;

FIG. 3 is a plan view showing a light-shielding mask according to the first embodiment of the present invention;

FIG. 4 is a plan view showing a pixel of a TFT substrate according to a second embodiment of the present invention;

FIG. 5 is a cross-sectional diagram taken along the line II-II of FIG. 4;

FIG. 6 is a plan view showing a light-shielding mask according to the second embodiment of the present invention;

FIG. 7 is a plan view showing a light-shielding mask according to a third embodiment of the present invention;

FIG. 8 is a plan view showing a pixel of a TFT substrate according to a fourth embodiment of the present invention;

FIG. 9 is a cross-sectional diagram taken along the line III-III of FIG. 8;

FIG. 10A is a plan view showing a light-shielding mask for forming transparent electrode and FIG. 10B is a plan view showing alight-shielding mask for forming reflecting electrode according to the fourth embodiment of the present invention;

FIG. 11 is a cross-sectional diagram showing a TFT array substrate according to a first conventional technique;

FIG. 12 is a plan view showing a pixel of a TFT substrate according to a second conventional technique;

FIG. 13 is a cross-sectional diagram showing a TFT array substrate according to the second conventional technique; and

FIG. 14 is a plan view showing a light-shielding mask according to the second conventional technique.

### PREFERRED EMBODIMENT OF THE INVENTION

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

### First Embodiment

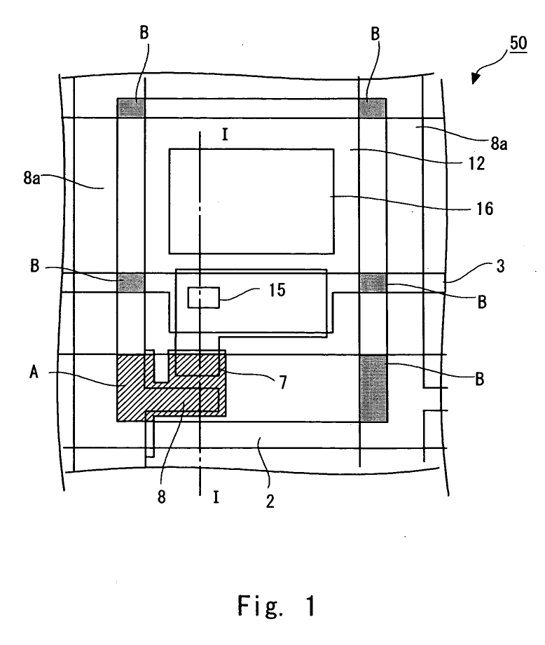

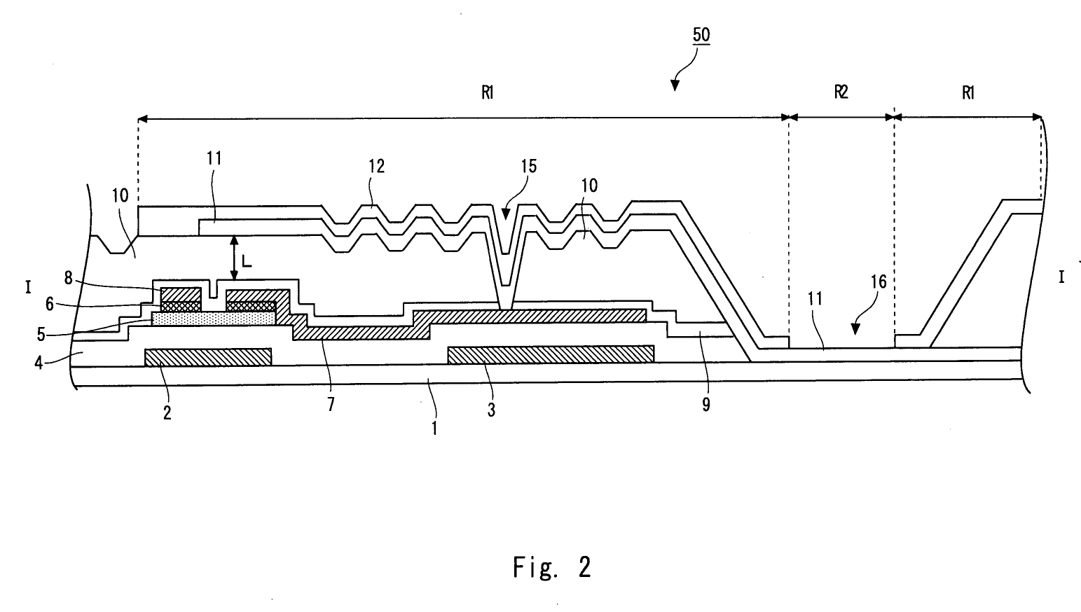

FIG. 1 is a plan view showing a pixel of a TFT array substrate 50 of a transflective liquid crystal display according to a first embodiment. FIG. 2 is a cross-sectional diagram taken along the line I-I of FIG. 1. The TFT array substrate 50 includes an insulating substrate 1 such as a glass substrate, a first conductive part, an interlayer insulating film 9, a planarizing film 10, and a second conductive part. The first conductive part is comprised of a gate line 2, an storage capacitor line 3, a gate insulating layer 4, a semiconductor active layer 5, which is a first semiconductor layer, an ohmic contact film 6, which is a second semiconductor layer, a drain electrode 7, a source electrode 8, and a source line 8a. The second conductive part is comprised of a transparent electrode 11, and a reflecting electrode 12.

A reflecting region R1 and a transparent region R2 are provided to the TFT array substrate 50 with bumpy pattern formed thereon. In the reflecting region R1, the transparent electrode 11 and the reflecting electrode 12 for each pixel are mounted. In the transparent region R2, the transparent electroe 11 for each pixel is mounted. The reflecting electrode 12 and the transparent electrode 11 form a pixel electrode of each pixel.

A manufacturing method of the TFT array substrate 50 of the first embodiment is explained hereinafter in detail. An example described hereinafter is a typical example, and other manufacturing method may be applied without departing from the scope and spirit of the invention.

Firstly clean a glass substrate as a insulating substrate 1 to clean its surface. A transparent insulating substrate such as glass substrate is used for the insulating substrate 1. Thickness of the insulating substrate 1 may be any thickness but preferably be less than or equal to 1.1 mm to realize a thin liquid crystal display. If the insulating substrate 1 is too thin, there could be problems such as deterioration in patterning accuracy because of a distortion in the substrate caused by various sorts of film formation and thermal history in processes. Thus the thickness of the insulating substrate 1 must be selected in the light of processes to be used. Furthermore, if the insulating substrate 1 is formed by brittle fracture material such as glass, it is preferable to chamfer edges of the substrate in terms of preventing foreign matter created from the chipping of the edges to be mixed in. Furthermore, it is preferable to provide a notch to a part of the insulating substrate 1 to be able to identify the direction of the substrate, as it facilitates process management.

After that, form a thin metallic film to form a gate line 2, a gate electrode (not shown) and storage capacitor line 3 by a method such as sputtering. For the thin metallic film, chromium, molybdenum, tantalum, titanium, aluminum, copper, or alloy added with these materials may be used to form a thin film with thickness of 100 nm to 500 nm. In a preferred embodiment, chromium having a thickness of 200 nm is used.

Then pattern the thin metallic film by a first photolithography process (photo-process) to form a gate electrode (not shown), a gate line 2, an storage capacitor electrode (not shown), an storage capacitor line 3, and a gate terminal (not shown). For example after cleaning, applying photosensitive resist, and drying the TFT array substrate, expose the TFT array substrate through a mask pattern with a specified pattern formed thereon to develop it. This photomechanically achieves a resist imprinted a mask pattern on the TFT array substrate. Then harden the photosensitive resist by heat, etch it to separate the photosensitive resist. This is how a photolithography process is performed. In case wetability between the photosensitive resist and the TFT array substrate is not satisfactory, rejecting the photosensitive resist, perform UV clean or apply HMDS (hexamethyldisilazane) by steam to improve wetability.

In a case adherence between the photosensitive resist and the TFT array substrate is not satisfactory, causing them to be separated, it is possible to increase temperature for heat hardening or extend the time for heat hardening. The thin metallic film may be wet etched using a known etchant (for example of the thin metallic film is formed by chromium, aqueous solution mixed with ammonium ceric nitrate and nitric acid). Further, it is preferable to etch the thin metallic film so that pattern edge is shaped in a taper, in terms of preventing short-circuiting at a bump with other lines. The taper shape refers to a pattern edge with its cross section shaped in a trapezoid. It is explained that in this process, the gate electrode (not shown), the gate line 2, the storage capacitor electrode (not shown), the storage capacitor line 3, and the gate terminal (not shown) are formed. However it is not limited to these but various sorts of marks or lines necessary to form the TFT array substrate may be formed.

Then sequentially form thin films to form the gate insulating film 4, the semiconductor active film 5, and the ohmic contact film 6 by plasma CVD method. For the thin film to form the gate insulating film 4, SiNx film, SiOx film, SiOzNw film, or multilayer film of these may be used (x, y, z, and w refer to positive values). The thickness of the thin film to form the gate insulating film is from 300 nm to 600 nm. Too thin film could cause a short-circuiting at an intersection of a gate and source lines. Accordingly it is preferable that the thickness of the thin film is more than the gate line 2 and the storage capacitor line 3. On the other hand, too thick film could cause ON current of the TFT to be smaller, lowering display characteristic. In a preferable embodiment, 100 nm SiN film is formed after forming 300 nm SiN film.

For the semiconductor active film 5, amorphous silicon (a-Si) film or polysilicon (p-Si) film are used. Thickness of the semiconductor active film 5 is from 100 nm to 300 nm. Too thin film could cause the loss in a dry etching for ohmic contact film 6. Too thick film could cause ON current of the TFT to be smaller. Therefore, in light of these issues, the thickness of the film is selected according to control on etching depth at a dry etching and condition of the ON current of the TFT.

In a case a-Si film is used as the semiconductor active film 5, it is preferable that a phase boundary with a-Si film as the gate insulating film 4 to be SiNx film or SiOzNw film. This increases Vth controllability and reliability of the TFT, The Vth is a gate voltage that makes the TFT conductive. Further, in a case a-Si film is used as the semiconductor active film 5, it is preferable to form the film around the phase boundary of the gate insulating film 4 with a condition having smaller deposition rate, and form the film of upper layers with a condition having larger deposition rate. This achieves a TFT characteristic with large mobility in a short time for forming the film, thereby reducing leakage current when TFT is turned off. In a preferred embodiment, 150 nm a-Si film is formed as the semiconductor active film 5. On the other hand in a case p-Si film is used as the semiconductor active film 5, a phase boundary with p-Si film as the gate insulating film 4 is preferably SiOy or SiOzNw film. This improves Vth controllability and reliability of the TFT.

As the ohmic contact film 6, n type a-Si film or n type p-Si film which are a-Si or p-Si doped with a small amount of phosphorus (P) is used. Thickness of the ohmic contact film 6 may be 20 nm to 70 nm. The SiNx, SiOy, SiOzNw, p-Si, n type a-Si, and n type p-Si films may be patterned by dry etching using known gas (SiH₄, NH₃, H₂, NO₂, PH₃, N₂, and mixed gas of these). In a preferred embodiment, 30 nm n type a-Si is formed as the ohmic contact film 6.

Then pattern the semiconductor active film 5 and the ohmic contact film 6 to at least the portion where TFT is formed by a second photolithography process. The gate insulating film 4 remains all over the surface of the insulating substrate 1. The semiconductor active film 5 and the ohmic contact film 6 are preferably patterned and remained to an intersection of source line and the gate line 2, and the storage capacitor line 3, not only to a portion where the TFT part is formed. This increases a withstand voltage of the intersection. Further, the semiconductor active film 5 and the ohmic contact film 6 in the TFT part are preferably remained underneath of the source line in a continuous shape. This makes the source electrode not to cross over bump of the semiconductor active film 5 and the ohmic contact film 6, thereby reducing the possibility of disconnection of the source electrode at the bump. The semiconductor active film 5 and the ohmic contact film 6 may be dry etched by known gas composition (for example mixed gas of SF6 and O₂, of CF₄ and O₂).

After that, form a thin metallic film to form the drain electrode 7 and the source electrode 8 by a method such as sputtering. For the thin metallic film, chromium, molybdenum, tantalum, titanium, aluminum, copper, alloy added with a small amount of these material, or multilayer film of these may be used. Needless to say that the above materials may be formed as a multilayer. In a preferred embodiment, chromium having a thickness of 200 nm is used.

Then pattern the thin metallic film to form the source line 8a (see FIG. 1), a source terminal, and the source electrode 8 and the drain electrode 7 by a third photolithography process. The source electrode 8 is formed over to a portion where the source lien and the gate line are intersected. The drain electrode 7 is formed over to the reflecting region R1. After that, etch the ohmic contact film 6. This process removes central part of the ohmic contact film 206 of the TFT portion, consequently exposing the semiconductor active film 5. The ohmic contact film 6 may be etched by known gas composition (for example mixed gas of CF₄ and O₂). This enables to dry etch the ohmic contact film 6.

Then form a film to form the interlayer insulating film 9 by plasma CVD method. Form the planarizing film 10 thereabove. The film to form the interlayer insulating film 9 may be of the same material as the gate insulating film 4. In a preferred embodiment, 100 nm SiN is used. The planarizing film 10 is photosensitive organic film and a known material can be used. For example positive photosensitive resin composite such as PC 335 or PC 405 made by JSR Corporation. Needless to say that negative photosensitive resin composite may be used. Thickness of the planarizing film 10 is from 3.0 to 4.0 μm, preferably from 3.2 to 3.9 μm. The thickness is not limited to this.

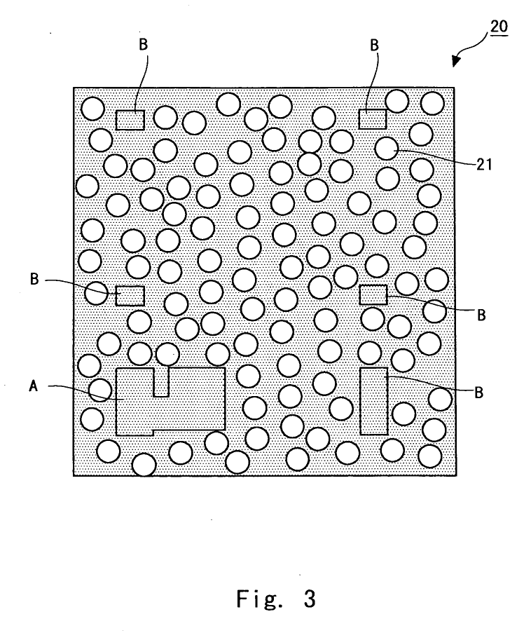

Form the planarizing film 10 in a desired pattern by a fourth and fifth photolithography process. In this process, bumpy pattern is formed on a surface of the planarizing film 10 in the reflecting region R1. Firstly expose the planarizing film 10 having no pattern formed thereon using a light-shielding mask (photomask) 20 having a light transmission parts 21 shown in FIG. 3 evenly and with low light intensity. Then expose the planarizing film 10 using a light-shielding mask (not shown) having openings that correspond to a transparent region 16 evenly and with high light intensity as shown in FIG. 1. The light transmission parts of the light-shielding mask 20 may be of circular shapes as shown in FIG. 3, for example. Its diameter may be 3 to 20 μm, for example.

After the exposing process, use developer to develop. This completely removes the planarizing film 10 in a region exposed with high light intensity. Further, the planarizing film 10 in a region exposed with low light intensity becomes thinner than original film. Consequently bumpy pattern 15 is formed on the surface of the planarizing film 10. The transparent electrode 11 and the reflecting electrode 12 are provided above a region A where thin film transistor is formed (hereinafter referred to as a region A), a region B where any of the source line 8a, the gate line 2, and the storage capacitor line 3 are intersected (hereinafter referred to as a region B) via the planarizing film 10. bumpy pattern is not formed on the surface of the planarizing film 10 located above the regions A and B using the light-shielding mask 20 shown in FIG. 3. Accordingly the planarizing film 10 above the regions A and B is flat. Therefore, bumpy pattern is not formed for the transparent electrode 11 and reflecting electrode 12. Instead of a method that controls pattern of the planarizing film 10 by changing light intensity, two different planarizing films may be applied to be exposed and developed to pattern them.

Then perform a heat treatment as necessary. After that, the interlayer insulating film 9 is removed by etching process in a region corresponding to the contact hole 13, thereby exposing the drain electrode 7. Furthermore in a region corresponding to the transparent region 16, the interlayer insulating film 9 and the gate insulating film 4 are removed by etching process, thereby exposing the insulating substrate 1.

After that, form a thin transparent conductive film to form the transparent electrode 11 by a method such as sputtering. As the thin transparent conductive film ITO, SNO₂, and IZO may be used. It is preferable to use ITO in light of chemical stability. In a preferred embodiment, 80 nm ITO is used.

Then pattern the thin transparent conductive film to achieve a desired pattern of the transparent electrode 11 by a sixth photolithography process. The thin transparent conductive film may be etched by a known wet etching depending on material to be used (for example of the thin transparent conductive film is made of crystallized ITO, use aqueous solution added with hydrochloric acid and nitric acid). In a case the thin transparent conductive film is ITO, it is possible to perform a dry etching using a known gas composition (for example HI and HBr). Furthermore in this process, a transfer pad may be formed to the TFT array substrate to electrically connect an opposing electrode of an opposing substrate with a common line of the TFT array substrate.

After that, form a thin metallic film to form the reflecting electrode 12 by a method such as sputtering. For the thin metallic film, metal having a reflecting function such as aluminum may be used. Thickness of the film may be from 100 nm to 500 nm, for example. Needless to say that abovementioned material may be formed to be a multilayer film.

Then pattern the reflecting electrode 12 in a desired pattern by a seventh photolithography process.

The TFT array substrate is manufactured by applying an orientation film thereon and rubbing it in a certain direction. The TFT array substrate manufactured as above is bonded with a CF substrate having an opposing electrode. Then spacers are provided between the substrates. And liquid crystal is injected in between the substrates. A liquid crystal display is manufactured by mounting a liquid crystal panel having the two substrates with a liquid crystal layer interposed therebetween to backlight unit. A polarizing plate or a phase difference plate may be mounted to the liquid crystal panel.

In a case a plurality of the first conductive parts such as thin film transistor, the gate line 2, and source line 8a are laminated on the TFT array substrate, thickness of the planarizing film 10 formed thereabove may fluctuate. This is because that a bump is generated depending on an degree of salient parts of the first conductive parts formed by regions where thin film transistor part, source line 8a, and gate line 2 are laminated. Therefore, in a case of forming bumpy pattern on the planarizing film 10 and a thinner portion of the planarizing film 10 overlaps with a depression portions of the bumpy pattern, the first and the second conductive parts that face each other via the planarizing film may be electrically connected, causing a short out. It consequently generates display defects such as bright spot.

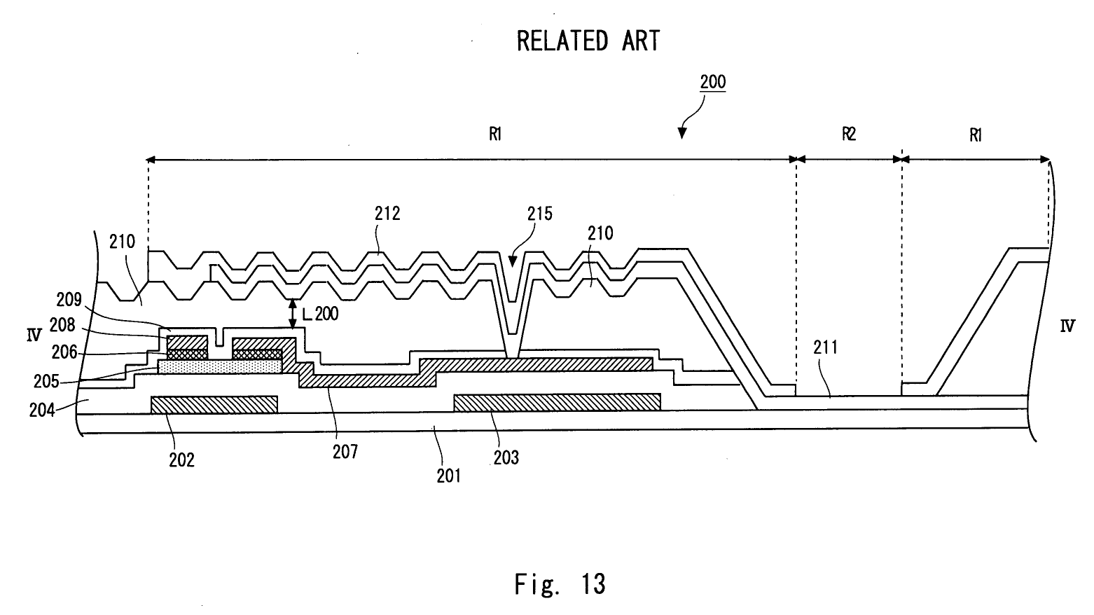

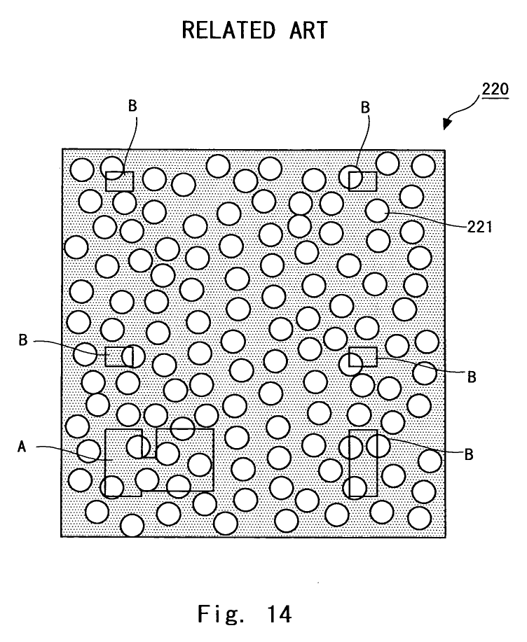

In the TFT array substrate 50 of the first embodiment, the transparent electrode 11 and the reflecting electrode 12 are provided above a region A where thin film transistor is formed, a region B where any of the source line 8a, the gate line 2, and the storage capacitor line 3 are intersected via the planarizing film 10. A plurality of multilayer films are formed in the regions A and B, thus the thickness of the planarizing film 10 is thinner than regions where less layers are formed. Patterning bumpy pattern to a thinner region could cause conductive parts above and below the planarizing film 10 to be electrically connected by process fluctuation. Therefore, bumpy pattern is not formed on the surface of the planarizing film 10 located above the regions A and B by the light-shielding mask 20. Consequently the film can be thicker (see L in FIG. 2) as compared to a case forming bumpy pattern above the regions A and B as shown in L200 in FIG. 13. It therefore reduces possibilities of a problem that a salient part of the first conductive part of line or TFT shorts out with a pixel electrode that is caused by a fluctuation in film thickness due to process fluctuation. Consequently the present invention provides a liquid crystal display that prevents from display defects such as bright spots having a high display quality and yield factor. Further, by the planarizing film 10 above the regions A and B to be thicker, a parasitic capacitance of a pixel electrode can be suppressed, thereby improving display quality. Further, by the pattern on the surface of the planarizing film 10, bumpy pattern is not formed to the transparent electrode 11 and the reflecting electrode 12 above the regions A and B.

In the first embodiment, a circular shape light-shielding is used to explain. However it is not restricted to this but can be triangle, rectangle, or cross shape, for example. Furthermore the first embodiment explained an example of not forming bumpy pattern on the surface of the planarizing film 10 located above the region A (where thin film transistor is formed) and the region B (not the region A and any of source line, gate line, and storage capacitor line are intersected). However it is not restricted to this but can be applied to at least a part of the surface of the planarizing film in an area with the different electric potential between the first and second conductive poritons among areas where the salient part of the first conductive part is formed with the second conductive part formed thereabove.

The first embodiment explained an example of a transflective liquid crystal display. However it is not restricted to this but can be applied to various display apparatuses such as a reflecting liquid crystal display. Further, the first embodiment described an example of including a thin film transistor substrate. However it is not restricted to this but can be applied to a display apparatus substrate having no switching element such as a TFT. It may be further applied to an overall thin film multilayer substrate having a first conductive and a second conductive parts respectively below and above the planarizing film having bumpy pattern on its surface.

### Second Embodiment

An embodiment different from the TFT array substrate 50 of the first embodiment is described hereinafter in detail. In the explanation below, components identical to those in the first embodiment are denoted by reference numerals identical to those therein with detailed description omitted as appropriate.

A TFT array substrate 50a of a second embodiment has the same basic configuration as the first embodiment excluding the following points. In the first embodiment, bumpy pattern is not formed on the surface of the planarizing film 10 below the reflecting electrode 12 located above the region A (where thin film transistor is formed) and the region B (where a plurality of the first conductive parts are intersected, seeing in the perpendicular direction to the insulating substrate 1). However in the second embodiment, the planarizing film 10 has a bumpy pattern on its surface above the regions A and B. Furthermore reflector electrode 12 of the first embodiment is formed in the same shape and same intensity in regions excluding the regions A and B. However for the reflecting electrode 12 of the second embodiment, depth of depression portions of bumpy pattern on the surface of the planarizing film above the regions A, B, and C is made shallower as compared to depth of depression poritons of bumpy pattern in other regions. The region C is a region other than the regions A and B and the source line 8a or the gate line 2 is formed thereto. Specifically, the region C is a region where the source line 8a, or the gate line 2 is formed among the regions excluding the region A and B.

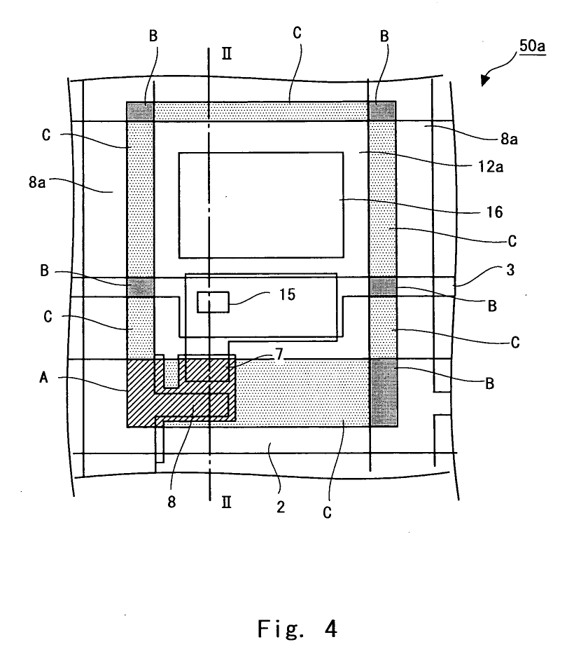

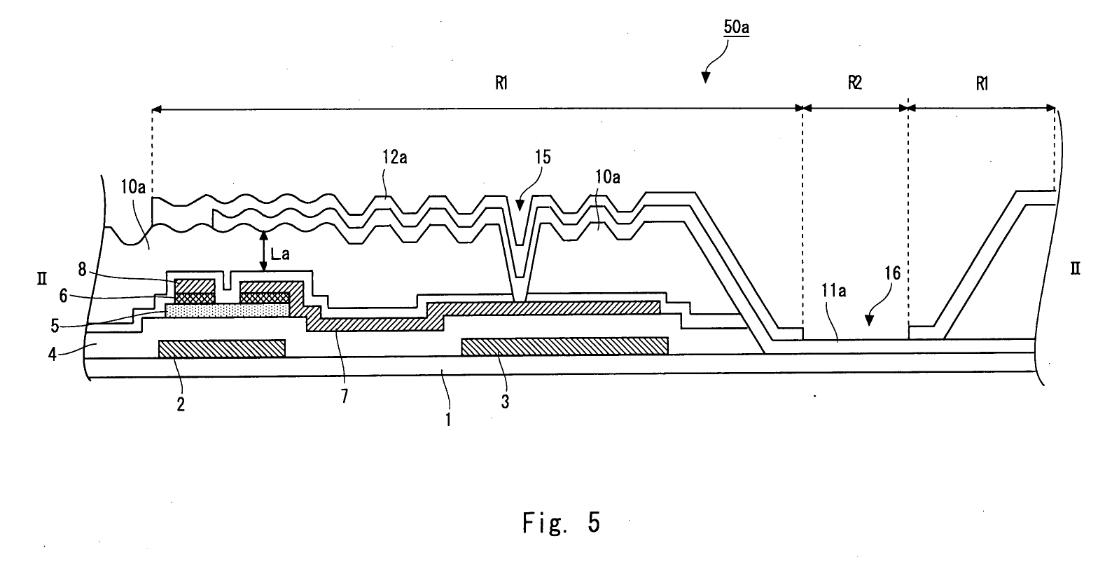

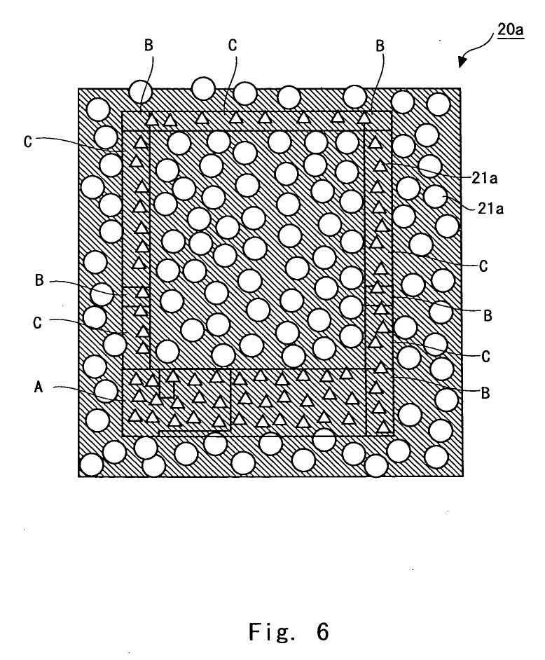

FIG. 4 is a plan view showing a pixel of the TFT array substrate 50a of a transflective liquid crystal display according to the second embodiment. FIG. 5 is a cross-sectional diagram taken along the line II-II of FIG. 4. As shown in FIG. 5, loose bumpy pattern is formed on the surface of the planarizing film 10 located above the regions A, B, and C. FIG. 6 is a view showing a light-shielding mask 20a for forming the bumpy pattern on the planarizing mask 10. As shown in FIG. 6, openings of a light transmission parts 21a of light-shielding mask 20a for the regions A, B, and C are formed to be smaller than openings of the light transmission parts 21a of the light-shielding mask 20a for other area.

According to the second embodiment, bumpy pattern for the regions A, B, and C can be flatter than other regions by using the light-shielding mask 20a having a pattern shown in FIG. 6. Accordingly a planarizing film La can be thicker. It therefore reduces possibilities of a problem that a pixel electrode shorts out with line and TFT that is caused by a fluctuation in film thickness due to process fluctuation. Consequently the present invention provides a liquid crystal display that prevents from generating bright spots having a high display quality and yield factor. Furthermore bumpy pattern is formed all over the surface of the reflecting electrode 12. It is therefore has wider reflection area as compared to the first embodiment, with an improvement in reflecting characteristic. Further, it is possible to restrain from increasing parasitic capacitance as compared to a conventional technique.

The second embodiment explained an example of reducing depth of depression poritons of the bumpy pattern on the surface of the planarizing film 10 above the region A (where the thin film transistor is formed), the region B (where any of the source line, the gate line, and the storage capacitor line are intersected and not the region A), and the region C (where the source line and gate lien 2 are formed and not the region A nor B) as compared to a depth of depression poritons of the bumpy pattern on the surface of the planarizing film 10 located above the regions excluding the abovementioned regions. However it is not restricted to this but can be applied to surface of at least a part of the planarizing film 10 having a different potential of the first and the second conductive parts among regions where salient parts of the first conductive part is formed and the second conductive part is formed thereabove.

### Third Embodiment

A third embodiment different from the TFT array substrate 50a of the second embodiment is described hereinafter in detail.

A TFT array substrate 50b of a third embodiment has the same basic configuration as the first embodiment excluding the following points. In the second embodiment, the same bumpy pattern is formed on the surface of the planarizing film above the regions A, B and C. However in the third embodiment, different bumpy patterns are formed to the surface of the planarizing film 10 above the regions A, B and C according to the regions.

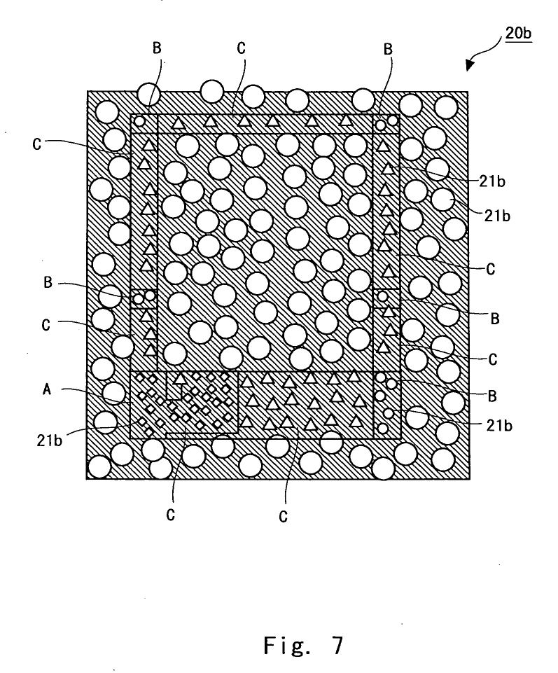

FIG. 7 is a plan view of a light-shielding mask 20b according to the third embodiment. As shown in FIG. 7, openings of light transmission parts 21b of light shielding mask 20b for the regions A, B and C are formed to be smaller than the openings of the light transmission parts 21b of light shielding mask 20b for the other region. In addition to that, the light transmission parts 21b having patterns different for the regions A, B, and C, so that thickness of the planarizing film 10 above the region will be most appropriate. For example depth of depression poritons of the bumpy pattern on the surface of the planarizing film 10 above the regions A, B, and C are formed to be region C>region B>region A by depth.

According to the third embodiment, the thickness of the planarizing film 10 for the regions A, B, and C can be optimized by using the light-shielding mask 20b having a pattern shown in FIG. 7. As a result, it is possible to reduce the reflecting electrode shorting out with a line or TFT that is caused by a fluctuation in film thickness from process fluctuation. Consequently the present invention provides a liquid crystal display that prevents from display defects such as bright spots having a high display quality and yield factor. Optimizing bumpy pattern on the surface of the reflecting electrode 12 can cause an improvement in reflecting characteristic as compared to the second embodiment. Further, it is possible to restrain from increasing parasitic capacitance as compared to a conventional technique.

The third embodiment explained an example of reducing depth of depression poritons of the bumpy pattern on the surface of the planarizing film 10 above the region A (where the thin film transistor is formed), the region B (where any of the source line 8a, the gate line, and the storage capacitor line are intersected), and the region C (where the source line 8a and gate lien 2 are formed and not the region A nor B) as compared to a depth of depression portions of the bumpy pattern on the surface of the planarizing film 10 located above the regions excluding the abovementioned regions. However it is not restricted to this but can be applied to surface of at least a part of the planarizing film 10 having a different potential of the first and the second conductive parts among areas where salient parts of the first conductive part is formed and the second conductive part is formed thereabove.

### Fourth Embodiment

An embodiment different from the TFT array substrate 50 of the first embodiment is explained hereinafter in detail.

In the first embodiment, bumpy pattern is not formed to the planarizing film 10 above the regions A and B. However in the fourth embodiment, the same bumpy pattern is formed to a planarizing film 10c above the regions A and B. Furthermore in the first embodiment, the transparent electrode 11 and the reflecting electrode 12 are formed over an upper layer of the planarizing film 10 above the regions A and B. However in the fourth embodiment, a transparent electrode 11c and a reflecting electrode 12 are not provided to depression portions of the bumpy pattern on the surface of the planarizing film 10c above the regions A, B and C.

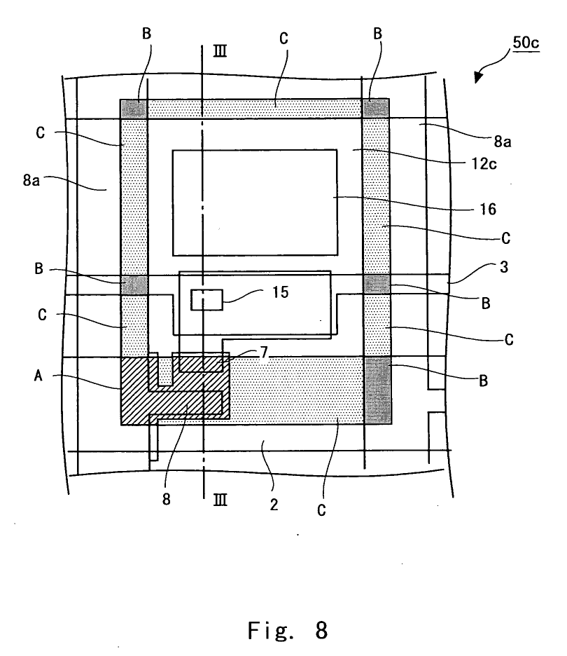

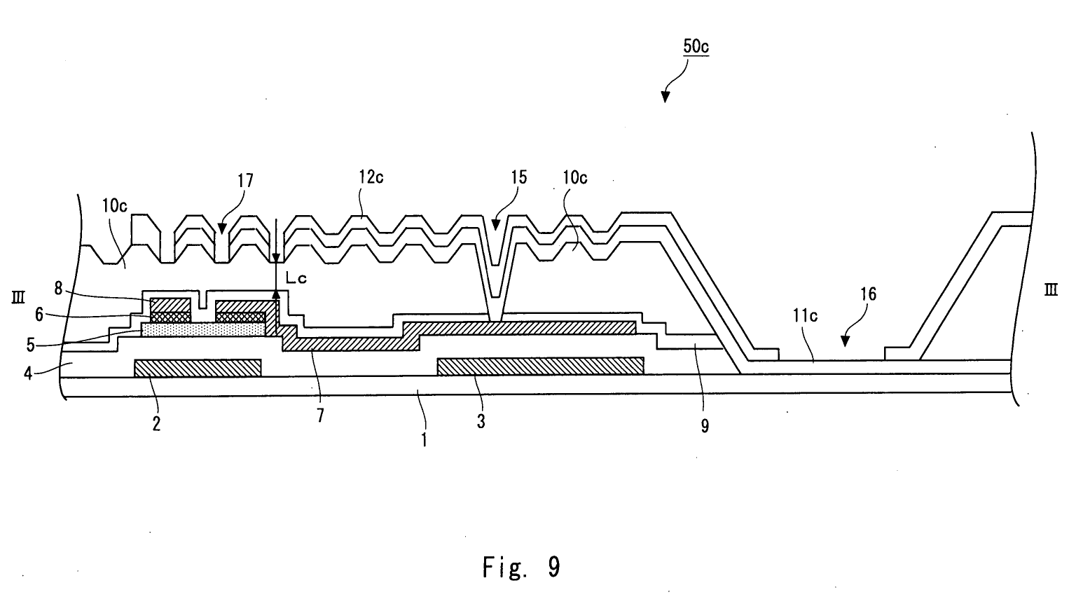

FIG. 8 is a pixel of a TFT array substrate 54 of a transflective liquid crystal display of the fourth embodiment. FIG. 9 is a cross-sectional diagram taken along the line III-III of FIG. 8. As shown in FIG. 9, the transparent electrode 11 and the reflecting electrode 12 are not provided to depression portions of the planarizing film 10 that are formed above the regions A, B, and C.

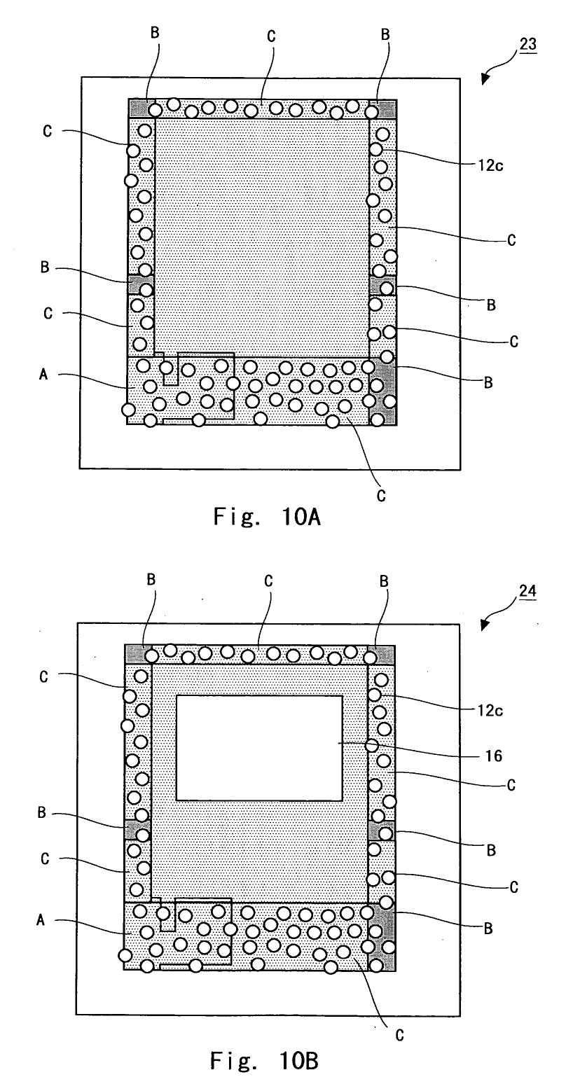

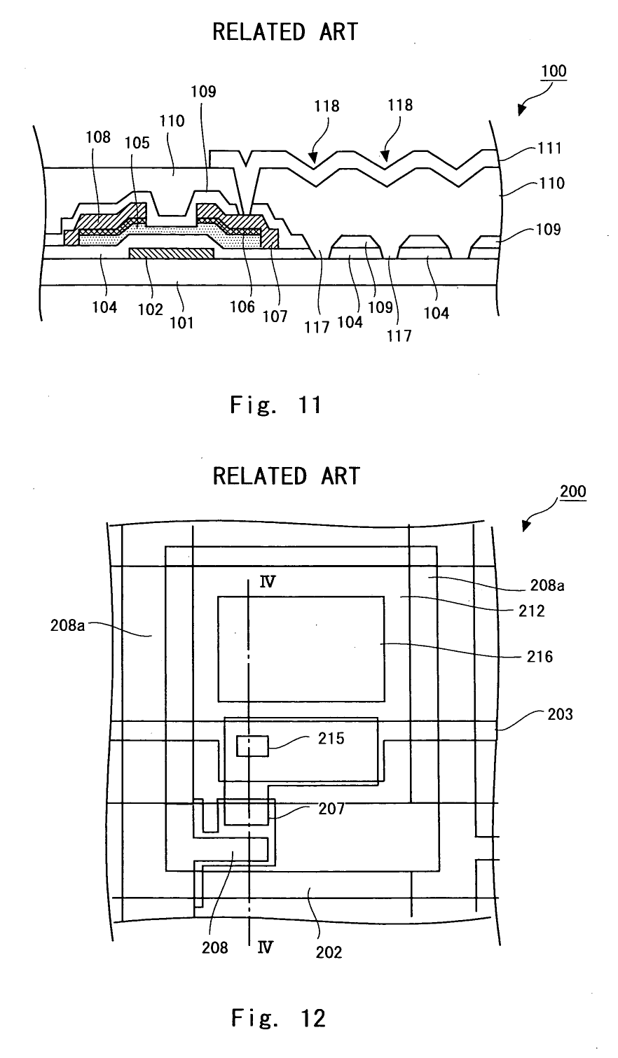

FIG. 10A is a view showing a light-shielding mask 23 for forming transparent electrode for patterning the transparent electrode 11c. FIG. 10B is a view showing a light-shielding mask 24 for forming reflecting electrode for patterning the reflecting electrode 12c. A resist is patterned using the light-shielding mask 23 for forming transparent electrode 11c and the light-shielding mask 24 for forming reflecting electrode 12c by the photolithography process described in the first embodiment. Then etch thin metallic films for forming the transparent electrode 11c and the reflecting electrode 12c. This realizes the transparent electrode 11c and the reflecting electrode 12c.

According to the fourth embodiment, the transparent electrode 11c and the reflecting electrode 12c are not formed to the bottom of depression portions of bumpy pattern of the planarizing film 10c by the TFT array substrate 50 having a pattern shown in FIG. 8. Accordingly it is possible to avoid a short out generated between a conductive electrode and a pixel electrode mounted to a layer below the planarizing film 10c that is caused by a fluctuation in process. Further, bumpy pattern can be deeper for the region where the planarizing film 10c becomes thinner, thereby increasing scatter components of reflectivity.

The fourth embodiment explained an example that the second conductive part is not formed to bottom of bumpy pattern on the surface of the planarizing film 10 located above the region A (where thin film transistor is formed), a region B (where any of the source line, the gate line, and the storage capacitor line 3 are intersected), and the region C (region not the regions A and B, and source line, and gate line 2 are formed thereto). However it is not restricted to this but may be applied to surface of at least a part of the planarizing film 10 having a different potential of the first and the second conductive parts among regions where salient parts of the first conductive part is formed and the second conductive part is formed thereabove.

What is claimed is:

1. A thin film multilayer substrate comprising:
a planarizing film having bumpy pattern on its surface on a substrate;
a first conductive part having a source line, a gate line, and an storage capacitor line below the planarizing film;
a second conductive part above the planarizing film;
a region A having a thin film transistor formed therein; and
a region B not the region A, and any of the source line, the gate line, and the storage capacitor line are intersected; wherein
the bumpy pattern on the surface of the planarizing film is formed to an area excluding an area with different electric potential between the first and the second conductive part among areas where the second conductive part is formed above the regions A and B.

2. A thin film multilayer substrate comprising:
a planarizing film with bumpy pattern on its surface on a substrate;
a plurality of first conductive parts below the planarizing part; and
a second conductive part above the planarizing film, wherein
at least a part of the depression poritons of bumpy pattern on the surface of the planarizing film in an area with different electric potential between the first and second conductive part among areas where an salient part of the first conductive part is formed with the second conductive part formed thereabove, is shallower than a depth of the bumpy pattern on the surface of the planarizing film above an area excluding areas where the salient part of the first conductive part is formed thereto.

3. The thin film multilayer substrate according to claim 2, wherein the region the salient parts of the first conductive part are formed comprising:
a region A where a thin film transistor is formed;
a region B where any of a source line, a gate line, and an storage capacitor line are intersected and not the region A; and
a region C where the source line and the gate lines are formed and not the region B, wherein a depth of depression portions of bumpy pattern on the surface of the planarizing film in an area where the second conductive part is formed above the regions A, B, and C, is shallower than depth of depression portions of bumpy pattern on the surface of the planarizing film above a region excluding the regions A, B, and C.

4. The thin film multilayer substrate according to claim 3, wherein shapes of bumpy patterns for the regions A, B, and C are different.

5. A thin film multilayer substrate comprising:
a planarizing film with bumpy pattern on its surface on a substrate;
a plurality of first conductive parts below the planarizing film; and
a second conductive part above the planarizing film,
wherein the second conductive part is not formed to at least a part of bottom of bumpy pattern on the surface of the planarizing film above a region where salient parts of the first conductive parts are formed.

6. The thin film multilayer substrate according to claim 5, further comprising:
a region A where a thin film transistor is formed;
a region B where any of a source line, a gate line, and an storage capacitor line are intersected and not the region A;
region C where the source line and the gate line are formed and not the region B, wherein
the second conductive part is not formed at bottom of bumpy pattern on the surface of the planarizing film in the regions A, B, and C.

7. A liquid crystal display comprising a thin film multilayer substrate according to claim 1.

8. A liquid crystal display comprising a thin film multilayer substrate according to claim 2.

9. A liquid crystal display comprising a thin film multilayer substrate according to claim 5.

10. A manufacturing method of a thin film multilayer substrate having a planarizing film with bumpy pattern on its surface on a substrate, a plurality of first conductive parts below the planarizing film, and a second conductive part above the planarizing film, the manufacturing method comprising:
forming the first conductive part on the substrate;
coating the planarizing film to an upper layer of the first conductive part;
adjusting a thickness of the planarizing film depending on a shape of salient parts of the first conductive parts formed below the planarizing film so that the first and the second conductive parts are not electrically connected; and
forming the second conductive part above the planarizing film with its thickness being adjusted, wherein
the adjustment of the thickness of the planarizing film is performed by changing a shape of bumpy pattern on the surface of the planarizing film according to the shape of the salient parts of the first conductive part.
